(19) United States
(12) Patent Application Publication
(10) Pub. No.: US 2003/0189913 A1
(43) Pub. Date: Oct. 9, 2003

(54) Methods of transmitting and executing contents of program for hand-held terminal

(76) Inventor: Hee-Sok Kim, Goyang-city (KR)

Correspondence Address: Y Rocky Tsao, Fish & Richardson, 225 Franklin Street, Boston, MA, 02110-2804, US

(21) Appl. No.: 10/311,448

(22) PCT Filed: Jul. 3, 2001
(86) PCT No.: PCT/KR01/01134

(30) Foreign Application Priority Data
Jul. 3, 2000 (KR) 2000/37653

(51) Int. Cl. H04Q 7/24

(52) U.S. Cl. 370/338; 370/352

(57) ABSTRACT

A method of transmitting contents of a program for a hand-held terminal is provided. The method comprises the steps of: accessing the terminal to a server through a wireless Internet, confirming kinds of services and contents menus contents program of the downloaded specific menu is selected by the terminal side, determining whether or not it is possible to receive the selected contents program by requesting a remaining memory capacitance of the terminal, a start address and specification of the terminal through an expansion script transmission.

### TECHNICAL FIELD

The present invention relates to a wireless Internet application for contents of a program, such as an application program or a game program, which is saved and run personally on a hand-held terminal. Specifically, while a specific program is downloaded into the terminal through a wireless Internet, this invention minimizes the amount of wireless transmission data by downloading a basic execution program code and data in advance, then downloading essential data selectively for application program a user wishes to run. Further, the invention is directed to methods of transmitting and executing contents of a program for a hand-held terminal wherein the methods support the ASP (Application Software Providing Service) which allows a user of the hand-held terminal to download contents of a desired program if there is a necessary application without storing in the terminal a variety of added functions except for a basic function for the calling.

### BACKGROUND ART

Recently, many people including young people as well as adults have a hand-held terminal due to rapid development of IT (Information telecommunication) technology and change of communication culture. This rapid and wide spread of the hand-held terminals made each manufactures give a great effort on product development and its differentiation. Therefore, lately announced products preferably have additional functions, for instance, video communication function, e-mail transmission/reception function, calculator function, game device function, etc., in addition to its inherent function of voice communication function.

Especially, the game program execution function among the additional ones of the hand-held terminal is gaining a great popularity from young generation.

Hand-held terminals including game execution function distributed on the open market store a regular code format of electronic entertainment game program in the terminal's internal memory. Therefore, a user of the hand-held terminal can enjoy a series of games using the hand-held terminal by manipulating keypads provided in front panel of the terminal.

Generally, the electronic entertainment game programs have a tendency that the more a gamer repeats a specific game, the less the possibility of enjoying the game again is. If the gamer executes again the game he/she won in former times, the interest regarding the game would be much lower than the former times.

However, memory capacitance of the hand-held terminal that is supported to store a game program is very limited, so that the terminal fails to store many different games. Especially, games stored in the hand-held terminal are different from ordinary computer game because of lack of its memory capacitance. So, a game which needs high complexity and large capacitance can not be implemented on the hand-held terminal.

This limitation is not only applied to the game program but other variety of application program. Solving this problem by adding an extra memory to the hand-held terminal might not be the practical answer for current trends of small-sized and low-cost device.

Thus, game program and other application software supported in the hand-held terminal should be set with a limited capacitance because of the limitation of its memory capacitance, which causes lack of variety of programs. In consequence, its utilization and interest by the owner of hand-held terminal is remarkably decreased.

To start with this point of view, recently, diversity of mobile service has been increased based on wireless Internet technology. In a mobile service through a wireless Internet communication between a hand-held terminal and a wireless Internet server, up to date, a user who wishes to run a game supported by the wireless Internet server downloads and saves it to a memory in a unit of program or game. Then, the user can execute the program or game on his hand-held terminal.

Thus, if the memory capacitance of the hand-held terminal of storing data is not expanded remarkably, it is not possible to retain or execute a game program having a size more than a constant memory capacitance. As a result, many limitations are followed during the management of the hand-held terminal. Especially, since downloading and executing technologies of game programs for the hand-held terminal are developed on condition that they would be executed on off-line, the conventional method has a drawback in that it is difficult to meet the requests of recent consumers in which an interactive support between the hand-held terminal and the wireless Internet server is preferred.

### DISCLOSURE OF THE INVENTION

Therefore, an object of the invention is to execute on the on-line or off-line a variety of game programs or application programs which are downloaded through the Internet to a hand-held terminal and support an ASP (Application Software Providing Service).

Another object of the invention is to effectively manage remaining spaces of an internal memory of a hand-held terminal without additively altering a design for the internal memory of the hand-held terminal, thereby effectively downloading and executing contents program such as a variety of game programs or application programs which are provided from a server computer.

Further another object of the invention is to allow a user to set an additional function except for a basic function for the calling by downloading the additional function through the Internet and allow a terminal manufacturer to manufacture a terminal having only an inherent calling function, thereby allowing the manufacture to avoid a load for research of such the additional function.

Further still another object of the invention is to download a basic program code and essential data in advance to a hand-held terminal and store the downloaded program code and essential data upon executing a specific game or contents in the one-line state and thus minimize the exchange amount of data between a wireless Internet station and the hand-held terminal, thereby increasing the executing speed of an on-line game.

To accomplish the above objects and advantages, there is provided a method of transmitting contents of a program for a hand-held terminal, the method comprising the steps of: accessing the terminal to a server through a wireless Internet, confirming kinds of services and contents menus provided by the server and selecting a download of a specific menu; if one contents program of the downloaded specific menu is selected by the terminal side, determining whether or not it is possible to receive the selected contents program by requesting a remaining memory capacitance of the terminal, a start address and specification of the terminal through an expansion script transmission; if it is determined that it is possible to receive the selected contents program, dividing the selected contents program into packets each having a size capable of being transmitted once and transmitting the packets in an expansion script file to the terminal; orderly receiving the packets of the contents program transmitted from the server side to the terminal side and storing the received packets in the order received at an nv memory of the terminal; and when the downloading of the selected contents program is completed, transmitting its result value to the server side.

Preferably, the contents program provided from the server side to the hand-held terminal is downloaded by first downloading a basic execution program code data and an essential data of a corresponding contents to the hand-held terminal and then selectively downloading only data applicable to the execution of the corresponding contents program and wherein the contents program is used attached to the basic execution program.

According to another aspects of the present invention, there is provided a method of transmitting contents of a program for a hand-held terminal, the method comprising the steps of: accessing a user terminal to a server through an Internet, confirming kinds of services and contents menus provided by the server, selecting a specific menu and downloading the contents program of the selected specific menu; accessing the user terminal to the hand-held terminal such that the downloaded contents program is again transmitted to the hand-held terminal; if one of the contents programs downloaded and stored in the user computer is selected by the hand-held terminal side, determining whether or not it is possible to receive the selected contents program by requesting a remaining memory capacitance of the terminal, a start address and specification of the terminal through an expansion script transmission; if it is determined that it is possible to receive the selected contents program, dividing the selected contents program into packets each having a size capable of being transmitted once and transmitting the packets in an expansion script file to the terminal; orderly receiving the packets of the contents program transmitted from the user terminal to the hand-held terminal and storing the received packets in the order received at an nv memory of the hand-held terminal; and when the downloading of the selected contents program is completed, transmitting its result value to the user terminal side.

### BRIEF DESCRIPTION OF THE DRAWINGS

The above object, other features and advantages of the present invention will become more apparent by describing the preferred embodiment thereof with reference to the accompanying drawings, in which:

FIG. 1 is a concept diagram of a service system for downloading a program of a server side to a hand-held terminal through a wiring or wireless Internet;

FIG. 2 is a block diagram of the hand-held terminal in accordance with one preferred embodiment of the present invention;

FIG. 3 is a flowchart showing a procedure for downloading an application program and a game program through a wireless Internet service and executing the downloaded programs;

FIG. 4 is a flow chart for describing a procedure for downloading a wireless Internet-based client contents program in accordance with another preferred embodiment of the present invention; and

FIG. 5 is a flowchart describing a procedure for setting the session of a TCP socket and managing the set session between the server and the hand-held terminal for supporting an on-line game and between the terminal area and a client contents area.

### BEST MODE FOR CARRYING OUT THE INVENTION

Now, preferred embodiments of the present invention will be described in detail with reference to the annexed drawings.

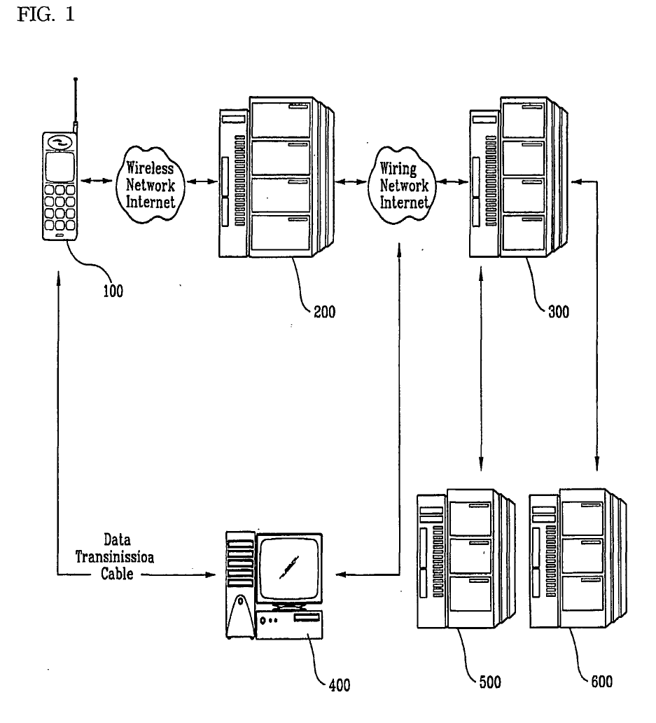

FIG. 1 is a concept diagram of a service system for downloading a program of a server side to a hand-held terminal through a wiring or wireless Internet.

Referring to FIG. 1, a hand-held terminal 100 is connected to a gateway 200 through a wireless network Internet. The gateway 200 is connected through a wiring network Internet to a server computer 300. The server computer 300 is connected to a contents DB 500 storing mobile contents including a variety of game programs and application programs and a membership DB 600 for membership management of a system.

As the application program among mobile contents, there are a car diary program, a calendar program, a new song download program, an alarm program, a word search program, a mirror making program, a computer program, a stop watch program, a dual clock program, a picture board program, a key Chinese character output program, a moving character occurrence program, etc.

User computer 400 (or client computer) accesses the server computer 300 through the wiring network Internet, downloads a variety of mobile programs and data from the contents DB 500 and stores the downloaded programs and data. The downloaded mobile contents can be transmitted to the hand-held terminal 100 through a private data transmission cable, i.e., through a wiring network.

Gateway 200 serves as transforming and transmitting a protocol for an access between the hand-held terminal 100 and the server 300 and a protocol requested mutually by an Internet TCP/IP protocol.

When the size of the mobile contents is considerably long and it takes a long time in downloading the mobile contents through the wireless network Internet or when it is requested to transform a part of the contents program, the user computer 400 has an advantage in transmitting a corresponding program through a wiring cable to the hand-held terminal 100 after downloading a content of the contents DB 500 connected to the server computer 300 and storing or processing the downloaded content.

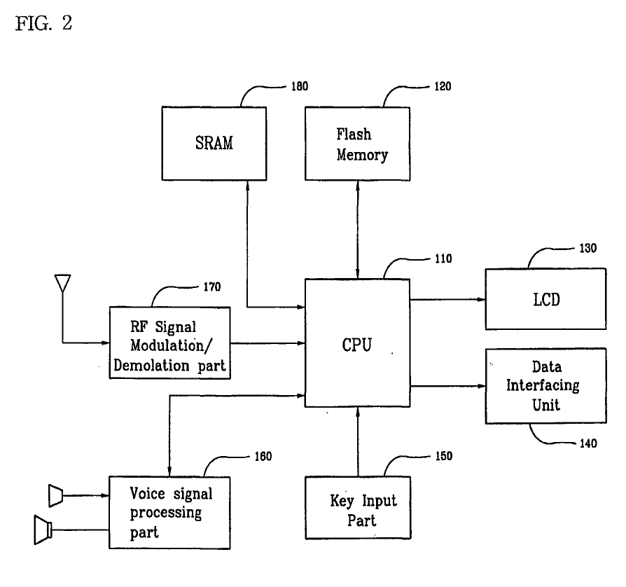

FIG. 2 is a block diagram of a hand-held terminal in accordance with one preferred embodiment of the present invention.

Referring to FIG. 2, a hand-held terminal includes a central processing unit (CPU) 110 for controlling and executing all operations of the hand-held terminal. A flash memory 120 is connected to the CPU 110 and it divides contents such as game data and their application programs and so on which are downloaded from the server into a program code and data and stores and deletes the program code and the data separately. An LCD 130 is connected to the CPU 110 and it displays various modes and contents of the hand-held terminal. An interface unit 140 is also connected to the CPU 110 and it interfaces data with an external apparatus such as the user computer 400. A key input part 150 is connected to the CPU 110 and it performs function selection and function conversion and supports a management of mobile contents. A voice signal processing part 160 is connected to the CPU 110. An RF signal modulation/demodulation part 170 is connected to the CPU 110 and it performs an access function with a portable communications station and the gateway 200. An SRAM 180 is connected to the CPU 110 and it temporarily stores a program for supporting an operating system (OS) of the mobile contents for the hand-held terminal and performs an inherent function for the hand-held terminal.

The flash memory 120 is operated with an inner space divided into three areas: a first area as a basic area of the terminal which stores a program necessary for performing an inherent function of the terminal; a second area as a client program download area which stores mobile contents and a program for the execution of the mobile contents; and a third area as a buffer memory area which temporarily stores a display control program followed by the execution of a client program and controls the LCD 130 of the terminal.

The memory size of the second area is not specified but is varied depending on the size of the client program. Various events information between the client program (including various contents programs downloaded to the terminal and a program built-in) and an inherent operation program of the terminal and their result values are exchanged between the basic area of the terminal (first area) and the program download area (second area).

As the event information provided from the basic area of the terminal to the client program operation area, there are gate start information, game end information, key event information, timer information, TCP connecting information, TCP disconnecting information, receipt data event information, control event information, etc.

To the contrary, as the event information provided from the client program operation area to the basic area of the terminal, there are result values information followed by executing the events and LCD picture display information through the memory buffer region of the LCD.

When the hand-held terminal performs an inherent function or is in the stand-by mode, an OS program for operating the terminal is temporarily stored in the SRAM 180. Also, when the hand-held terminal executes a client program (mobile contents), an application program for executing corresponding contents is temporarily stored in the SRAM 180.

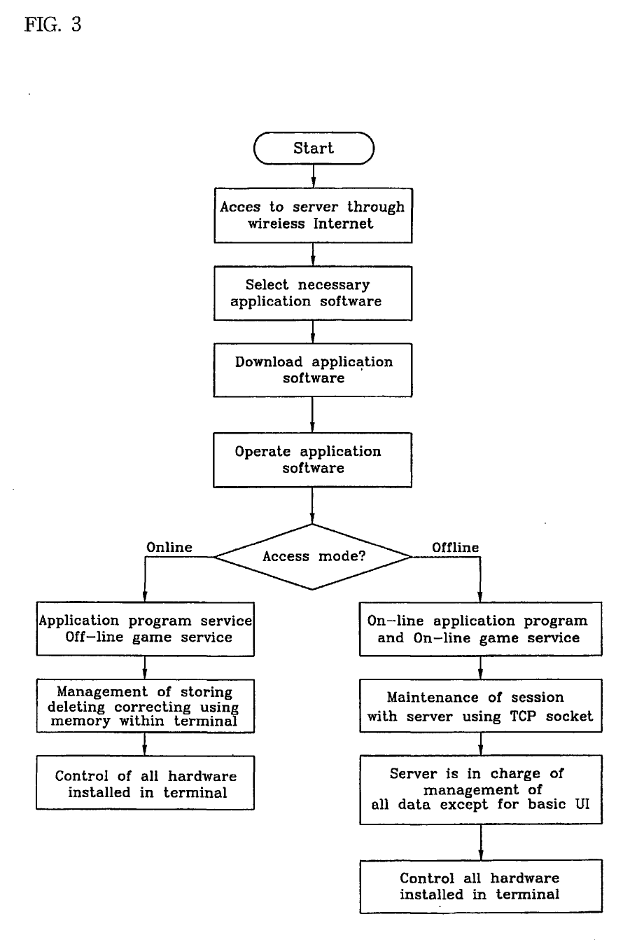

FIG. 3 is a flowchart showing a procedure for downloading an application program and a game program through a wireless Internet service and executing the downloaded programs. The flow chart is largely divided into a downloading service portion and an execution service portion.

The downloading service portion includes the steps of: accessing a server using a hand-held terminal; selecting mobile contents such as necessary game program, application program (application software) and so on through a menu selection; and downloading the selected contents to the downloading area of the flash memory of the hand-held terminal.

The executing service portion includes the steps of: operating mobile contents programs including application software; determining whether the current execution program is an on-line service mode program or an off-line service mode program; when it is determined that the current execution program is the off-line service mode program, performing to store, delete and correct program and data and controlling a related hardware provided in the terminal; and when it is determined that the current execution program is the on-line service mode program, maintaining a session with the wireless Internet server using a TCP socket and controlling a related hardware provided in the terminal wherein a management of all data except for a basic user interface (UI) is executed in the server.

When contents program of the hand-held terminal provided from the server is downloaded using the user computer and then the downloaded contents program is again transmitted to the hand-held terminal, the execution flow is as follows.

A user accesses the user computer to the server computer through the Internet. The user confirms kinds of services and contents menu provided by the server computer and selects a specific menu to download the specific menu.

After that, the user accesses the user computer to the hand-held terminal through a private data cable in order to again transmit the downloaded contents program to the hand-held terminal.

If one of the contents programs downloaded and stored in the user computer is selected at the hand-held terminal side, the user computer determines whether or not it is possible to receive the selected contents program in the hand-held terminal by requesting a remaining memory capacitance of the terminal, a start address and specification of the terminal through an expansion script transmission.

If it is determined that it is possible to receive the selected contents program in the hand-held terminal, the user computer divides the selected contents program into packets each having a size capable of being transmitted once and transmits the packets in an expansion script file to the hand-held terminal.

The hand-held terminal orderly receives the divided packets of the contents program transmitted from the user computer and stores the received packets in the order received at an nv memory of the hand-held terminal.

When a series of downloadings of the selected contents program is completed, its result value is transmitted to the user terminal side.

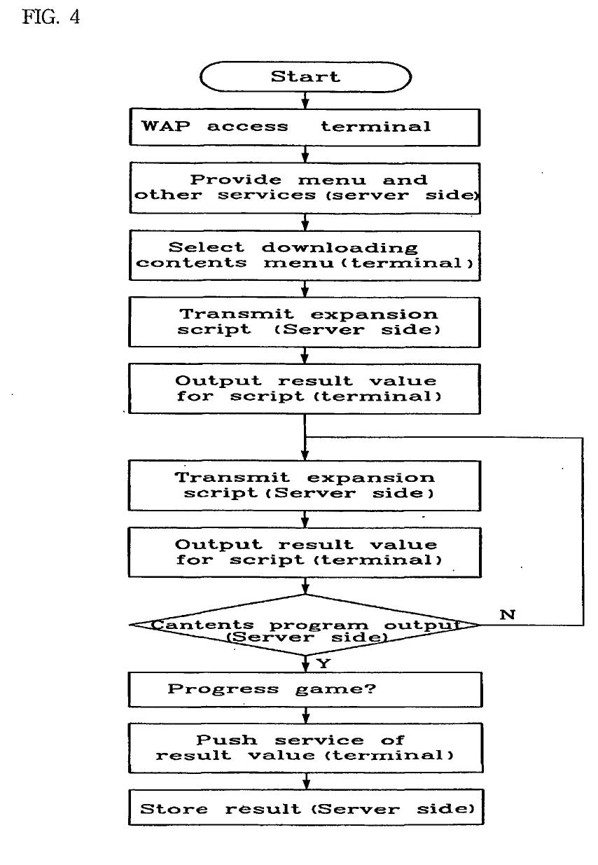

FIG. 4 is a flow chart for describing a procedure for downloading a wireless Internet based client contents program in accordance with another preferred embodiment of the present invention.

This flow chart shows the execution procedures in the hand-held terminal and the server separately in an access state of the hand-held terminal and the server through a wireless Internet gateway.

First, as a user of a hand-held terminal accesses a server computer through a wireless Internet using the hand-held terminal, service menus provided from the server computer is displayed on the LCD window of the hand-held terminal. The user can select a specific menu of the displayed service menus by manipulating direction keys of the hand-held terminal.

Thus, when a specific menu is selected at the hand-held terminal side, the server side requests a remaining usable memory capacitance, a start address and specification of the corresponding hand-held terminal through a script transmission [MGIget_Info( )].

As the hand-held terminal transmits a result as a response of the request to the server side, the server side determines whether or not it is possible for the corresponding terminal to receive the selected contents program. In other words, the server side determines whether or not the hand-held terminal secures a sufficient memory space to receive the size of the selected contents program and whether or not the hand-held terminal has an executable specification. Here, MGI is an abbreviation of mobile game interface.

In the meanwhile, when the server side determines that the hand-held terminal is in an executable condition to download the selected program, the selected contents program, the server divides the selected contents program into packets each having a size capable of being transmitted once and transmits the divided packets to the hand-held terminal in an expansion script file [MGIset_Info( )]. After the server confirms the completing of one packet transmission from a result value every packet, it transmits a next packet. This transmission of the contents program in a unit of packet continues until all of the selected contents programs are completely downloaded, and the downloaded contents programs are stored in an nv (nonvolatile) memory of the hand-held terminal.

If the size of the selected contents program and its execution condition are not acceptable at the corresponding hand-held terminal, the server side notifies the no of the downloading and returns to the initial mobile contents menu selection step such that the terminal side selects another contents menu.

As the downloading of the program data of the selected menu has been completed, the hand-held terminal side is allowed to execute the downloaded program, for instance, game program. If a push service corresponding to a final state information value followed by the execution of the game program is provided by the server side, its result value is uploaded to the server side and is stored in a private DB of the server.

The execution procedure of downloading these contents programs is specifically reviewed. The hand-held terminal notifies the server side of a usable memory capacitance and a start address of the hand-held terminal through a WML expansion script. To do so, the hand-held terminal confirms memory capacitances of the ROM and RAM by a size input into the hand-held terminal and then notifies the server side of whether or not to secure a sufficient memory capacitance and a start address as an absolute address. If a sufficient memory size corresponding to the size of the downloaded program data is not secured, the hand-held terminal notifies the server side of no-service as a result value. Also, if kind of data (kindofdata) that are not supported is designated, the hand-held terminal notifies the server side of no-service as a result value.

In the above execution procedure, when it is assumed that the WML script is MGIget_Infor(kindofdata, size 1, size 2), if a value of the parameter “kindofdata” is “0”, it can be used as a classifier defining an off-line game and if a value of the parameter “kindofdata” is “1”, it can be used as a classifier defining an on-line game. Parameter “size 1” is meant by a real size of a client execution code portion and parameter “size 2” is meant by a real size of a client data portion.

Also, output values have types of “flag”, “*ROM_addr”, “*RAM_addr”, “typeofLCD”, “typeofsound” and “ver”. Here, the “flag” is used in indicating whether or not a service is provided, in which “0” means yes of the service and “1” means no of the service. The “*ROM_addr” indicates a start address of a flash memory to store a program. (Hex value) The “*RAM_addr” indicates a start address of a RAM necessary for the execution of a program. (Hex value) The “typeofLCD” decides an output way depending on the specification of the hand-held terminal. The “typeofsound” decides an output way depending on the sound specification of the hand-held terminal. The “ver” indicates version information of a compiler language.

Based on the above definition, WML script information of the hand-held terminal is exemplarily expressed as follows:

MSGget_Info(0, 42750, 1720, 1, 1, 0).

In the meanwhile, the WAP server side divides the contents program such as game program, etc downloaded to the WML expansion script into packets each having a size (4-5 Kbytes) capable of being transmitted once and it transmits the divided packets to the hand-held terminal side. When the divided packets data having the size of 4-5 Kbytes are received at the hand-held terminal side, the data are stored in the order received in the nv (nonvolatile) memory, for example, flash memory.

The hand-held terminal manages the start timing and the ending timing of the downloading in the form of flag. Thus, in order to prevent an occurrence of a circumstance which the hand-held terminal fails to download a corresponding program, the hand-held terminal should have proper means to notify the user of the hand-held terminal of such a failure of the downloading.

In case that WML script is MGIset_Info(url, title, data), the parameter “url” indicates an absolute path of the contents program files such as a game program, etc within the server, the parameter “title” indicates the title of the client program which is being stored in the hand-held terminal and the “data” indicates the client program which is downloaded in real.

The “data” portion has a structure of the following table 1.

TABLE 1

| | | |
|---|---|---|
| Header portion | Type of packet (typeofpacket) | Byte |
| | Total number of packets (totalpacket) | Word |
| | Number of current packet | Word |
| | (currentpacket) | |
| | Data length (length) | Word |
| Real data portion | Real data | Byte |

In the meanwhile, when it is classified according to types of output, “O” indicates the receipt completion of a packet (receipt completion of final packet), “1” indicates the normal receipt of a current packet and “2” indicates the abnormal receipt of a current packet.

The server script information is exemplarily expressed as follows:

MSGget_Info(“http://www.mobiletop.co.kr/game101.cgi”, “entertainment quiz”, 42{.}).

Next, there is described a procedure for supporting an operation of a game program or application client program as downloaded.

In order to normally operate a game or application client program which was downloaded, the hand-held terminal has to have an ability capable of generating an event.

All events that the downloaded client program needs are designated in the form of input argument (MGIcall) with calling the code start address notified to the server side upon downloading the contents program.

Also, for a result on calling the client program, a buffer which is declared in a static type in the client program is declared in a structure type and then a corresponding result value (MGIret) is transferred into a basic area (first area) of the flash memory within the hand-held terminal.

Accordingly, interfacing between all of the client programs and the basic area of the hand-held terminal is progressed in a way of receiving a result occurred by calling a function.

In the meanwhile, the wireless Internet server classifies the contents program provided to the hand-held terminal into execution program code data serving as base program thereof and data managed attached on the execution program. Accordingly, the hand-held terminal side preferentially downloads and stores the execution program code and its essential data as the client program. After that, the hand-held terminal allows the terminal's user to selectively download from the server only data of an application mode that is managed in the execution program within the hand-held terminal and to combine the data of the application mode with the previously downloaded execution program for the use of the data of the application mode.

Table 2 shows details of call functions for the execution of the previously described client program [MGIret*MGIcall(arg1, arg2, arg3, . . . )].

TABLE 2

| Arg#1 | Arg#2 | Arg#2 | Description |
|---|---|---|---|
| E1_START | | | This is an event to execute a client program and |
| | | | indicates to start initializing an operation |
| | | | necessary for the progress of the client program. |
| E1_END | | | This is an event to end a client program and |
| | | | indicates to end the progress of all programs and |
| | | | transfer a control to the hand-held terminal. |
| E1_KEY | E2_VALUE | | This is an event to transfer a corresponding key |
| | | | value to a client program upon inputting a key |
| | | | signal at the hand-held terminal. *KEY VALUE: |
| | | | 0-9, *, #, upper, lower, left, right, minimum, |
| | | | confirmation, etc. |
| E1_TMER | | | This is an event of periodically occurring in order |
| | | | to progress a client program in which a |
| | | | corresponding timer value is notified from the |
| | | | client program to the hand-held terminal side |
| | | | when E_START is received. |
| E1_GET_EVENT | | | This is an event to confirm whether or not there |
| | | | exists an event to transmit from a client program |
| | | | to a hand-held terminal. This is called once |
| | | | during a pause period at the hand-held terminal. |
| E1_SOCKET | E2_ACTIVE | | This is an event to notify that the session between |
| | | | a server and a hand-held terminal is access- |
| | | | maintained in a program such as on-line game |
| | | | operated accessed with the server. |
| | E2_DEACTIVE | | When a TCP socket session between a server and |
| | | | a hand-held terminal is released due to a weak |
| | | | electric field or other reason during the |
| | | | communication, this event notifies a client of |
| | | | such a fact. |
| | E2_DATA | E3_BUF* | This is an event to notify a client program of data |
| | | | received from a server. A corresponding content |
| | | | can be varied at any times depending on contents |
| | | | and scenarios. |
| E1_CNTL | E2_GET_NV | E3_BUF* | When a client requests data within a specific |
| | E2_GET_BATRY | E3_VALUE | This is an event to notify a client of a consumed |
| | | | amount of a hand-held terminal's battery as |
| | | | requested by the client. |
| | E2_GET_RTC | E3_BUF* | This is an event to notify a client of current data |
| | | | and time information. The event transfers current |
| | | | time in an absolute time of second unit. |
| | E2_GET | E3_VALUE | This is an event to notify a client of an intensity |
| | SIGNAL | | of an electric field of a hand-held terminal. |
| | E2_GET | E3_VALUE | This is an event to notify a client of pin signals of |
| | SIOCNTL | | SIO ports of a hand-held terminal. |
| | E2_GET | E3_BUF* | This is an event to transmit data received at SIO |
| | SIODATA | | ports of a hand-held terminal into a client. |

In the meanwhile, in a processing and supporting procedure of result values of a downloaded client program, functions which should be processed at the hand-held terminal side with respect to values occurred by executing a client program based on the table 2 are shown in table 3.

TABLE 3

| Event | Sub-argument | Description |
|---|---|---|
| E_NOTE_LCD | LCD BUF* | This event notifies a hand-held terminal of a point of an LCD |
| | | buffer which should be shared between the hand-held terminal |
| | | and a client program. |
| E_NOTE_IP | IP#1 | This event notifies a hand-held terminal of an IP address of a |
| | IP#2 | server for a TCP socket access with the server. |
| | IP#3 | |
| | IP#4 | |
| E_NORT_PORT | PORT No. | This event notifies a hand-held terminal of numbers of ports |
| | | used with IP address. |
| E_NOTE_TMER | Timer Tick Value | This is an event that requests a basic timer value necessary for |
| | | the execution of a client program of a hand-held terminal. This |
| | | event can be varied depending on the specification of the |
| | | hand-held terminal and has to generate the most adjacent timer |
| | | when no-supported. |
| E_SET_SOUND | BUF* | This is an event used when a client program generates an |
| | | effect sound. |
| E_SET_SOCKET | BUF* | This is an event used when there exist data transmitted from a |
| | | client program to a sever side. |
| E_SET_NV | BUF* | This is an event used when there exist data that a client |
| | | program wishes to store in an NV memory within a hand-held |
| | | terminal. |
| E_SET_MELODY | INDEX | This event selects a melody that a hand-held terminal wishes |
| | | to output among basic melodies retained at the terminal. |
| E_SET_IMAGE | INDEX | This event selects an image or an animation stored in a hand- |
| | | held terminal. |
| E_SET_LED | FLAG | This event turns on or off a display LED placed at an upper |
| | | portion of a hand-held terminal. “0”-Off, “1”-On |
| E_SET_VIBRAT | FLAG | This event turns on or off a vibrator of a hand-held terminal. |
| | | “0”-Off, “1”-On |
| E_SET_LIGHT | FLAG | This event turns on or off a backlight of a hand-held terminal. |
| | | “0”-Off, “1”-On |
| E_SET_VOL | INDEX | This event controls a sound output of a hand-held terminal |
| E_SET_KEY | INDEX | This event generates an effect which a key button of a hand- |
| | | held terminal is pushed. |
| E_SET | FLAG | This event designates control rights for an external interfacing |
| SIOALERT | | unit of a hand-held terminal. “0”-no control rights, “1”- |
| | | designation of control rights. |
| E_SET SIOCOTL | VALUE | This event designates pin signals for an external interfacing |
| | | unit of a hand-held terminal. |
| E_SET SIODATA | BUF* | This is an event used when transmitting data to an external |
| | | interfacing unit of a hand-held terminal. |
| E_SET | INDEX | This event allows designating the contrast of an LCD of a |
| CONTRAST | | hand-held terminal. |
| E_SET_NV | | This event reads out values stored in an NV memory of a |
| | | hand-held terminal. |
| E_GET_BATRY | | This event reads out a residual capacitance of a battery of a |
| | | hand-held terminal. |
| E_GET_RTC | | This event reads out a current time within a hand-held |
| | | terminal. |
| E_GET_SIGNAL | | This event reads out a current intensity of an electric field |
| | | within a hand-held terminal. |
| E_GET SIOCNTL | | This event reads out a current state of an external interfacing |
| | | unit within a hand-held terminal. |

Next, a session support of the TCP socket is described.

In a case when a client program downloaded to a hand-held terminal side is an on-line game or an application of a service client concept, a TCP socket should be opened for the lasting transmission/reception of data.

The TCP socket session is managed at a management region of the hand-held terminal side. The client program area is allowed to notify the hand-held terminal side of IP address and port number of the server side which are necessary for the opening of the socket.

IP address, port number, etc., of each server are managed at respective client program areas and thus a management of C/P is freely performed.

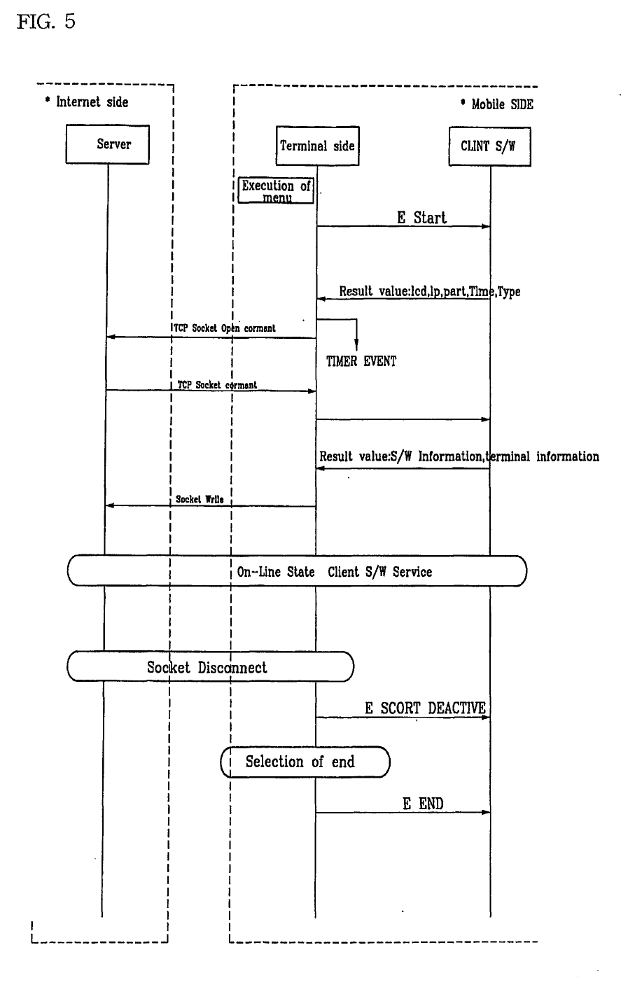

FIG. 5 is a flowchart describing procedures of setting the session of the TCP socket for supporting an on-line game and of managing the set session between a server and a hand-held terminal and between a basic program management area of the hand-held terminal and a client program management area.

The flow chart illustrates an information exchanging procedure between the server and the hand-held terminal and an exchanging procedure of an event and its result value between the terminal side and the client side within the hand-held terminal on a series of time axis.

First, if a user of a hand-held terminal input an execution command of an on-line contents menu, the hand-held terminal side transmits an event of E_START to a client software (program) side. As the event is input, the client software side transmits result values (LCD, IP, port, time, type) to the hand-held terminal side.

From this time, a timer event is executed at the hand-held terminal side and the terminal side requests an opening of the TCP socket from the server side. In response to the request, the server side executes a connecting of the TCP socket.

As the connecting of the TCP is executed, the hand-held terminal side transmits an event of E_SOCKET_ACTIVE to the client program side. As a result value responding to the transmission of the event, software information, hand-held terminal information, etc., are transmitted from the client side to the hand-held terminal side.

As the result value is input to the terminal side, the terminal side transmits a SOCKET WRITE to the server side to thereby support an execution of the client software in on-line state.

After that, if the TCP socket maintenance state between the server side and the terminal side is disconnected, the terminal side transmits an event of E_SOCKET_DEACTIVE to the client side and when there is a selection of the end by the user, the terminal side again transmits an event of E_END to the client side, thereby ending the execution of on-line contents using the hand-held terminal.

The aforementioned wireless Internet on-line service is managed on the basis of an application program downloaded previously in a state that a hand-held terminal is on-line accessed to a wireless Internet server on-line. Unlike this, it is possible to execute off-line an application program which was downloaded and is stored in a flash memory of a hand-held terminal.

While the methods of the present invention have been described in detail with reference to the preferred embodiments, those skilled in the art will appreciate that various modifications and substitutions can be made thereto without departing from the spirit and scope of the present invention as set forth in the appended claims.

### INDUSTRIAL APPLICABILITY

As described above, the present invention has the following advantages:

When downloading contents such as a variety of game programs or their application programs, etc., from a wireless Internet server to a hand-held terminal, a remaining memory space except for the basic memory space of the hand-held terminal can be effectively used. Especially, in the execution of on-line game, etc., since a basic program code every content and essential data followed by the program code are stored (downloaded) in advance in the hand-held terminal, exchange amount of data between a wireless Internet station and the hand-held terminal is minimized, thereby remarkably enhancing the execution speed of the game or contents. As a result, a limitation in the communication speed is removed and thus there occurs a specific effect to provide a foundation capable of converting a main stream of the wireless Internet service from a text base to a graphic base.

Further, since the invention allows a user to set an added function except for a basic function for the calling by downloading the added function through the Internet, it is possible for a terminal manufacturer to manufacture a terminal having only an inherent calling function, thereby allowing the manufacture to avoid a load for research of such the added function.

1. A method of transmitting contents of a program for a hand-held terminal, the method comprising the steps of:
accessing the terminal to a server through a wireless Internet, confirming kinds of services and contents menus provided by the server and selecting a download of a specific menu;
if one contents program of the downloaded specific menu is selected by the terminal side, determining whether or not it is possible to receive the selected contents program by requesting a remaining memory capacitance of the terminal, a start address and specification of the terminal through an expansion script transmission;
if it is determined that it is possible to receive the selected contents program, dividing the selected contents program into packets each having a size capable of being transmitted once and transmitting the packets in an expansion script file to the terminal;
orderly receiving the packets of the contents program transmitted from the server side to the terminal side and storing the received packets in the order received at an nv memory of the terminal; and
when the downloading of the selected contents program is completed, transmitting its result value to the server side.

2. A method of transmitting contents of a program for a hand-held terminal, the method comprising the steps of:
accessing a user terminal to a server through an Internet, confirming kinds of services and contents menus provided by the server, selecting a specific menu and downloading the contents program of the selected specific menu;
accessing the user terminal to the hand-held terminal such that the downloaded contents program is again transmitted to the hand-held terminal;
if one of the contents programs downloaded and stored in the user computer is selected by the hand-held terminal side, determining whether or not it is possible to receive the selected contents program by requesting a remaining memory capacitance of the terminal, a start address and specification of the terminal through an expansion script transmission;
if it is determined that it is possible to receive the selected contents program, dividing the selected contents program into packets each having a size capable of being transmitted once and transmitting the packets in an expansion script file to the terminal;
orderly receiving the packets of the contents program transmitted from the user terminal to the hand-held terminal and storing the received packets in the order received at an nv memory of the hand-held terminal; and
when the downloading of the selected contents program is completed, transmitting its result value to the user terminal side.

3. The method of claim 1 or claim 2, wherein the contents program provided from the server side to the hand-held terminal is downloaded by first downloading a basic execution program code data and an essential data of a corresponding contents to the hand-held terminal and then selectively downloading only data applicable to the execution of the corresponding contents program and wherein the contents program is used attached to the basic execution program.

4. A method of executing contents of a program for a hand-held terminal on-line, the method comprising the steps of:
transmitting a start event (E_START) from the hand-held terminal side to a client program side when a current state is an execution condition of on-line contents menu by a user of the hand-held terminal;
if the event is input, transmitting result values of LCD, IP, port, time and type to the hand-held terminal side at the client program side and executing a timer event at the hand-held terminal side;
after the timer event has been executed, requesting opening of a TCP socket to a server side and executing a connecting of the TCP socket depending on the opening request at the server side;
if the connecting of the TCP socket is executed, transmitting a socket activation event (E_SOCKET_ACTIVE) from the hand-held terminal side to the client program side;
transmitting information including software information and hand-held terminal information as a result value of the socket activation event from the client program side to the hand-held terminal side; and
writing the result value of the socket action event from the hand-held terminal side to the server side to support an execution of a client software in on-line state.
